(19) United States
(12) Patent Application Publication
(10) Pub. No.: US 2026/0286885 A1
(43) Pub. Date: Sep. 24, 2026

(54) CLOSED BRAYTON CYCLE SHUTDOWN CONTROL WITH CHARGEABLE FLUID RESERVOIR FOR COOLING ELECTRICAL COMPONENTS

(71) Applicant: Rolls-Royce North American Technologies Inc., Indianapolis, IN (US)

(72) Inventors: Neil Backus, Indianapolis, IN (US); Michael Monzella, Indianapolis, IN (US)

(21) Appl. No.: 19/086,053

(22) Filed: Mar. 20, 2025

(51) Int. Cl. F02C 1/10; F02C 1/05

(52) U.S. Cl. CPC F02C 1/10; F02C 1/05; F05D 2220/76

(57) ABSTRACT

A power-generation system includes an electrical system, a turbine engine, and a fluid control system. The turbine engine includes a compressor configured to receive and compress a working fluid, a heat source that transfers heat to the compressed working fluid, a turbine fluidly connected with the compressor to extract work from the heated working fluid and drive rotation of the compressor, and a first heat-exchanger fluidly connected with the turbine to transfer heat away from the heated working fluid to provide a cooled working fluid. The fluid control system fluidly is connected with the electrical system and the turbine engine to circulate the working fluid through the electrical system and the turbine engine.

### FIELD OF THE DISCLOSURE

The present disclosure relates generally to closed Brayton cycle power-generation systems, and more specifically to controlling the temperature of electrical hardware that is powered by such systems.

### BACKGROUND

Brayton cycle power-generation systems may be used to power spacecraft, aircraft, watercraft, and power generators. Conventional power-generation systems include a turbine engine having a compressor configured to compress a working fluid, a heat source for heating the compressed working fluid, and a turbine that extracts work from the heated compressed working fluid to power a fan, shaft, generator, etc. Power-generation systems may be open loop or closed loop.

In some systems, the heat from the heat source is transferred to the working fluid with a heat exchanger such that no combustion products travel through the compressor or the turbine. This may allow externally-heated gas turbine engines to operate with fuel sources that may ordinarily damage or are not compatible with the internal components of the system. In closed Brayton cycle systems, the working fluid is recirculated through the compressor, the heat exchanger, and the turbine. In open Brayton cycle systems, new working fluid may be continuously introduced to the compressor.

The components of the power-generation system, including electrical systems powered by the turbine engine, generate heat during operation. There remains interest in controlling a temperature of the components and electrical systems in Brayton cycle power-generation systems to avoid overheating of the components.

### SUMMARY

The present disclosure may comprise one or more of the following features and combinations thereof.

A power-generation system may comprise an electrical system, a turbine engine, and a fluid control system. The fluid control system may be fluidly connected with the electrical system and the turbine engine to circulate working fluid through the electrical system and the turbine engine.

In some embodiments, the electrical system may include a motor-generator and an electric power conditioning and distribution system connected with the motor-generator. The motor-generator may be operable in a power-generation mode to produce electrical energy and a motor mode to convert the electrical energy into rotational power. The electrical system may be configured for fluid cooling for removing heat from the electrical system.

In some embodiments, the turbine engine may include a compressor, a reactor heat-exchanger downstream of the compressor, a turbine downstream of the reactor heat-exchanger, and a cooling heat-exchanger downstream of the turbine. The compressor may be configured to receive the working fluid and compress the working fluid to provide a compressed working fluid. The reactor heat-exchanger may transfer heat from a nuclear reactor to the compressed working fluid to provide a heated working fluid. The turbine may be configured to extract work from the heated working fluid and drive rotation of the compressor and the motor-generator. The cooling heat-exchanger may transfer heat away from the heated working fluid to provide a cooled working fluid.

In some embodiments, the fluid control system may include a reservoir tank configured to store an amount of the working fluid, an inlet valve located upstream of the reservoir tank, and a controller coupled to the inlet valve. The reservoir tank may have an inlet fluidly connected downstream of the compressor and a primary outlet fluidly connected upstream of the electrical system. The inlet valve may be configured to change between an open position in which the inlet valve allows the compressed working fluid to flow to the reservoir tank and a closed position in which the inlet valve blocks the compressed working fluid to the reservoir tank to isolate the reservoir tank from the turbine engine.

In some embodiments, the controller may be configured to direct the inlet valve to change from the closed position to the open position in response to a shutdown of the turbine engine in which a speed of the compressor and the turbine is below a predetermined speed to allow the working fluid in the reservoir tank to flow to the electrical system so as to lower an overall equilibrium temperature of the working fluid after the shutdown of the turbine engine The controller may be configured to direct the inlet valve to be in the closed position during a start-up of the turbine engine and direct the inlet valve to change from the closed position to the open position after the start-up of the turbine engine to divert compressed working fluid to the reservoir tank. The controller may be configured to direct the inlet valve to change from the open position to the closed position after the start-up of the turbine engine in response to a pressure of the reservoir tank being equal to or greater than a predetermined pressure.

In some embodiments, the reservoir tank may include a main tank section and an auxiliary tank section separate from the main tank section. The reservoir tank may have a secondary outlet fluidly connected downstream of the cooling heat-exchanger. The inlet and the primary outlet may be in fluid communication with the main tank section and the secondary outlet may be in fluid communication with the auxiliary tank section.

In some embodiments, the reservoir tank may include a tank body and an internal divider. The tank body may define an interior space of the reservoir tank. The internal divider may be in the interior space to divide the interior space into the main tank section and the auxiliary tank section.

In some embodiments, the fluid control system may further include at least one outlet valve downstream of the reservoir tank. The at least one outlet valve may be configured to change between the open position in which the at least one outlet valve allows the working fluid stored in the reservoir tank to flow to the electrical system and the closed position in which the at least one outlet valve blocks the working fluid from flowing from the reservoir tank.

In some embodiments, the fluid control system may include a first outlet valve located downstream of the secondary outlet of the reservoir tank and upstream of the primary outlet of the reservoir tank. In some embodiments, the fluid control system may further include a second outlet valve located downstream of the primary outlet of the reservoir tank and downstream of the first outlet valve.

In some embodiments, the fluid control system may further include an outlet valve located downstream of the reservoir tank. The outlet valve may be configured to change between the open position in which the outlet valve allows the working fluid stored in the reservoir tank to flow to the electrical system and the closed position in which the outlet valve blocks the working fluid from flowing from the reservoir tank.

In some embodiments, the motor-generator may be coupled with the compressor. The motor-generator may be configured to operate in the motor mode to start the turbine engine and to operate in the power-generation mode to be driven by the turbine and generate the electrical energy.

According to another aspect of the present disclosure, a power-generation system may comprise an electrical system, a turbine engine, and a fluid control system. The turbine engine may include a compressor, a heat source, a turbine engine, and a first heat-exchanger. The compressor may be configured to receive a working fluid and compress the working fluid to provide a compressed working fluid. The heat source may transfer heat to the compressed working fluid to provide a heated working fluid. The turbine may be fluidly connected with the compressor to extract work from the heated working fluid and drive rotation of the compressor. The first heat-exchanger may be fluidly connected with the turbine to transfer heat away from the heated working fluid to provide a cooled working fluid.

In some embodiments, the fluid control system may include a reservoir tank configured to store an amount of the working fluid, a valve system, and a controller. The reservoir tank may be fluidly connected downstream of the compressor and upstream of the electrical system. The valve system may be fluidly connected to the reservoir tank to control a flow of working fluid through the reservoir tank. The controller may be coupled to the valve system to move the valve system between a closed mode in which the valve system blocks the working fluid from flowing through the reservoir tank in response to operation of the turbine engine and an open mode in which the valve system allows the working fluid to flow through the reservoir tank in response to a shutdown of the turbine engine.

In some embodiments, the controller is configured to direct the valve system to be in the closed mode during a start-up of the turbine engine and direct the valve system to change from the closed mode to a charging mode after the start-up of the turbine engine. In the charging mode, the valve system may allow the working fluid to flow to the reservoir tank and block the working fluid from flowing from the reservoir tank. The controller may be configured to direct the valve system to change from the charging mode to the closed mode after a start-up of the turbine engine in response to a pressure of the reservoir tank being equal to or greater than a predetermined pressure.

In some embodiments, the reservoir tank may include a main tank section and an auxiliary tank section separate from the main tank section. The reservoir tank may have an inlet fluidly connected downstream of the compressor, a primary outlet fluidly connected upstream of the electrical system, and a secondary outlet fluidly connected downstream of the first heat-exchanger. The inlet and the primary outlet may be in fluid communication with the main tank section and the secondary outlet may be in fluid communication with the auxiliary tank section.

In some embodiments, the reservoir tank may include a tank body and an internal divider. The tank body may define an interior space of the reservoir tank. The internal divider may be in the interior space to divide the interior space into the main tank section and the auxiliary tank section.

In some embodiments, the valve system may include an inlet valve located upstream of the reservoir tank. In some embodiments, the valve system may further include at least one outlet valve located downstream of the reservoir tank.

In some embodiments, the valve system may further include a first outlet valve and a second outlet valve. The first outlet valve may be located downstream of the secondary outlet of the reservoir tank and upstream of the primary outlet of the reservoir tank. The second outlet valve may be located downstream of the primary outlet of the reservoir tank and downstream of the first outlet valve.

According to another aspect of the present disclosure, a method of operating a power-generation system may comprise compressing a working fluid with a compressor, heating the compressed working fluid, rotating a turbine with the heated working fluid, and cooling the heated working fluid after rotating the turbine with the heated fluid. The method may further include conducting electrical energy to at least one electrical component, cooling at least one electrical component with the cooled working fluid, and conducting the working fluid from the at least one electrical component to the compressor.

In some embodiments, the method may further include conducting at least a portion of the compressed working fluid to a reservoir tank fluidly connected downstream of the compressor in response to a shutdown in which a speed of the compressor and the turbine is below a predetermined speed to cause the working fluid stored in the reservoir tank to flow to the at least one electrical component. The reservoir tank may include a main tank section and an auxiliary tank section separate from the main tank section. The method further includes selectively conducting the working fluid stored in the auxiliary tank section to the at least one electrical component.

In some embodiments, the method may further comprise driving a generator. The method may include driving a generator with the work extracted from the turbine to produce the electrical energy.

These and other features of the present disclosure will become more apparent from the following description of the illustrative embodiments.

### BRIEF DESCRIPTION OF THE DRAWINGS

FIG. 1 is a diagrammatic view of a power-generation system according to the present disclosure, the system includes an electrical system, a turbine engine, and a fluid control system fluidly connected with the electrical system and the turbine engine to circulate the working fluid through the electrical system and the components of the turbine engine, and further showing the fluid control system includes a reservoir tank for storing an amount of the working fluid, a valve system fluidly connected to the reservoir tank to control the flow of working fluid through the reservoir tank, and a controller coupled to the valve system to control switching the valve system between an open mode as shown in FIG. 4 and a closed mode as shown in FIGS. 2 and 3;

FIG. 2 is a diagrammatic view similar to FIG. 1 showing the system has changed from a reservoir tank charging mode as shown in FIG. 1 to a normal operation mode in which the turbine engine is running and the valve system is moved to the closed mode to block the flow of compressed working fluid to the reservoir after the reservoir tank has been charged to a predetermined pressure;

FIG. 3 is a diagrammatic view similar to FIG. 2 showing the system has changed from the normal operation mode as shown in FIG. 2 to a shutdown-initiated mode in which an operating speed of a compressor and a turbine of the turbine engine begins to slow down while the valve system remains in the closed mode;

FIG. 4 is a diagrammatic view similar to FIG. 3 showing the system has changed from the shutdown-initiated mode as shown in FIG. 3 to a shutdown-complete mode in which the operating speed of the compressor and turbine of the turbine engine is below a predetermined speed and the valve system changes to the open mode to allow the compressed working fluid to flow to and from the reservoir tank; and

FIG. 5 is a diagrammatic view of another embodiment of a power-generation system that includes an electrical system, a turbine engine, and a fluid control system fluidly connected with the electrical system and the turbine engine, and further showing the fluid control system including a reservoir tank having main tank section and an auxiliary tank section separate from the main tank section.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

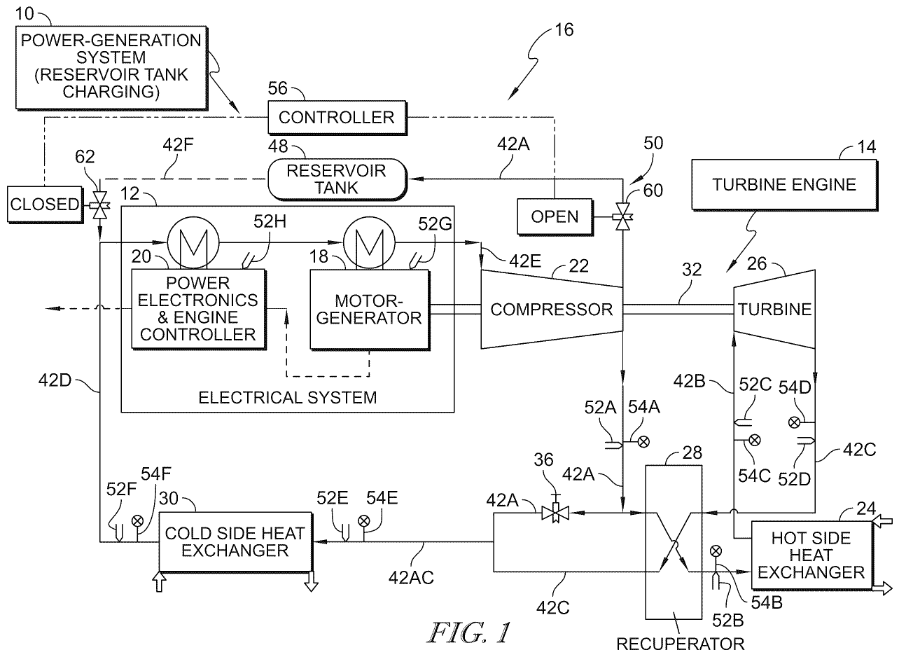

An illustrative power-generation system 10 includes an electrical system 12, a turbine engine 14, and a fluid control system 16 fluidly connected with the electrical system 12 and the turbine engine 14 to circulate working fluid through the electrical system 12 and the turbine engine 14 as shown in FIGS. 1-4. The turbine engine 14 includes a compressor 22 that compresses a working fluid 42E to provide compressed working fluid 42A, a heat source 24, illustratively a reactor heat-exchanger 24, downstream of the compressor 22 that heats the compressed working fluid 42A to provide heated compressed working fluid 42B, and a turbine 26 downstream of the heat source 24 that extracts work from the heated compressed working fluid 42B to provide low-pressure working fluid 42C and drive rotation of the compressor 22.

In some embodiments, the turbine engine 14 includes an optional heat recuperator 28 that pre-heats the compressed working fluid 42A using heat from the low-pressure working fluid 42C, as shown in FIG. 1. The turbine engine 14 further includes a cooling heat-exchanger 30 arranged downstream of the turbine 26 that cools the low-pressure working fluid 42C received from the turbine 26 to provide cooled working fluid 42D.

The electrical system 12 is configured to produce electrical energy from the rotational power of the turbine engine 14 and/or convert the electrical energy into rotational power. The components of the electrical system 12 may have temperature limits such that the electrical system 12 is cooled during operation of the system 10. Other system have a separate dedicated cooling system for the electrical system 12. This allows the temperature of the electrical system 12 to be independently controlled, but adds components and complexity to the overall system.

To minimize components and secondary cooling systems, the electrical system 12 of the present application is located downstream of the cooling heat-exchanger 30 and configured for fluid cooling for removing heat from the electrical system 12. In this way, the cooled working fluid 42D from the cooling heat-exchanger may be used to cool the electrical system 12. During steady state operation, the cooling heat-exchanger 30 lowers the working fluid temperatures to an acceptable range to cool the whole system 10 as well as the electrical system 12.

The ability to pass the cooled working fluid across the electrical system 12 is maintained while the turbomachinery operating and moving fluid throughout the system 10. During a shutdown, the speed of the compressor 22 and the turbine 26 drops below a predetermined speed as the turbine engine 14 comes to a stop. Upon shutdown of the turbine engine 14, the system 10 will tend towards an equilibrium temperature with higher temperature and pressure states (e.g., within the turbine 26) dominating the overall equilibrium. This is due to the significantly higher volume of fluid at high temperatures rather than lower temperatures. Without the system 10 operating, the cooling capabilities may be minimized or eliminated such that sufficient heat is not rejected from the electrical system 12 to the working fluid or excessive heat from the working fluid is transferred to the electrical system.

The equilibrium temperature may be higher than acceptable or desired operating temperatures of the electrical system 12. Therefore, the fluid control system 16 is fluidly connected with the electrical system 12 and the turbine engine 14 to circulate the working fluid through the electrical system 12 and the turbine engine 14. The fluid control system 16 controls the flow of the working fluid through the electrical system 12 and the turbine engine 14 in order to prevent the delicate power conversion equipment of the electrical system 12 from being exposed to these high temperatures during shutdown.

The fluid control system 16 of the present disclosure is adapted to thermally protect the electrical system 12 during and after shutdown of the system 10. In the illustrative embodiment, the fluid control system 16 includes a reservoir tank 48 configured to store an amount of working fluid that provides additional thermal mass for the system 10. The working fluid in the reservoir tank 48 may be isolated from a majority of the working fluid during operation of the system 10 and thus kept at a lower temperature. After the shutdown, the fluid control system 16 allows the working fluid to flow through the reservoir tank 48, causing the cooler working fluid in the reservoir tank 48 to flow through electrical system 12. As a result, the equilibrium temperature is lowered to acceptable or desired operating temperatures of the electrical system 12 thereby preventing the electrical system 12 from being exposed to high-temperature after the shutdown.

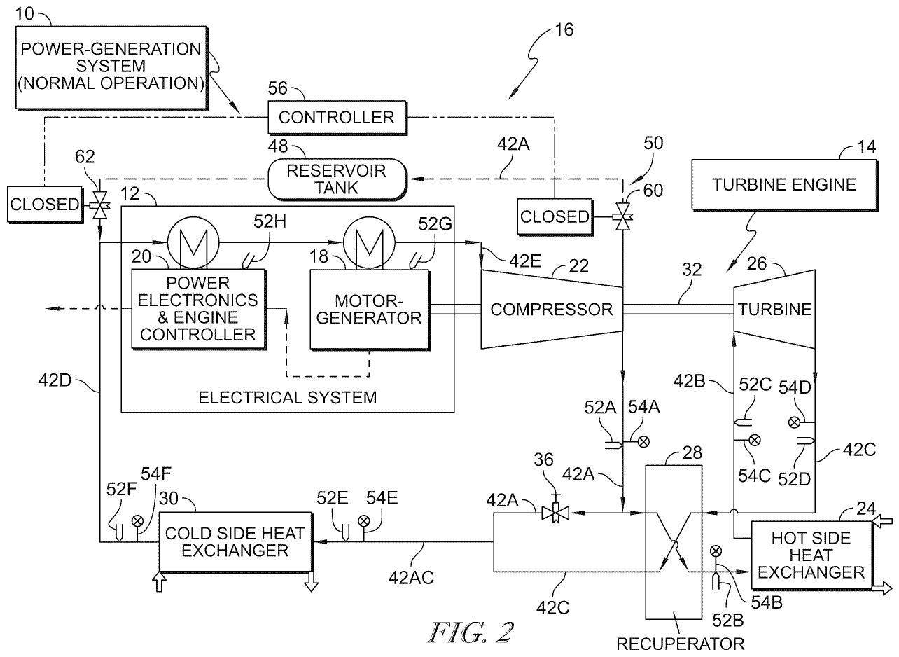

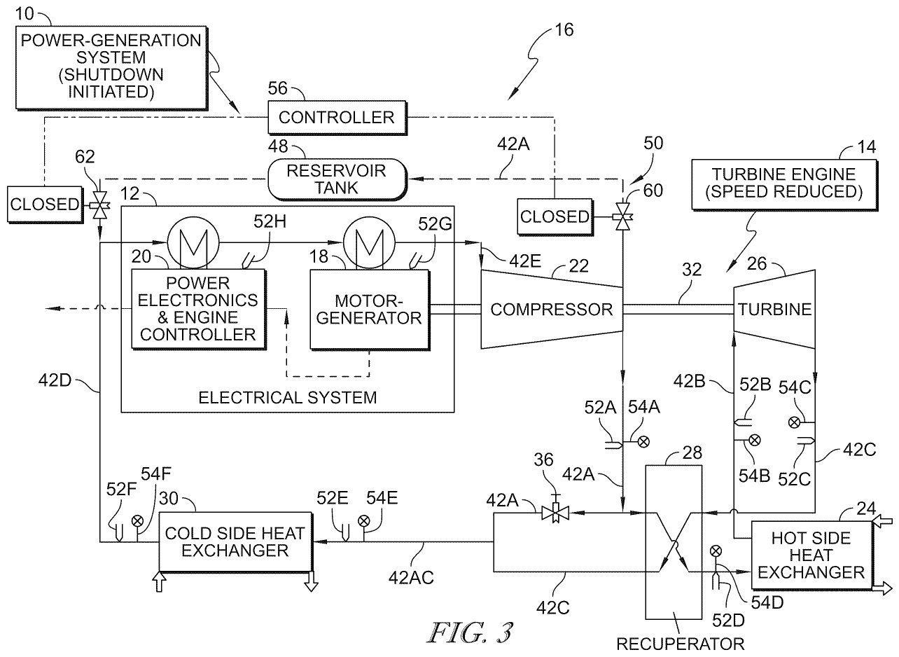

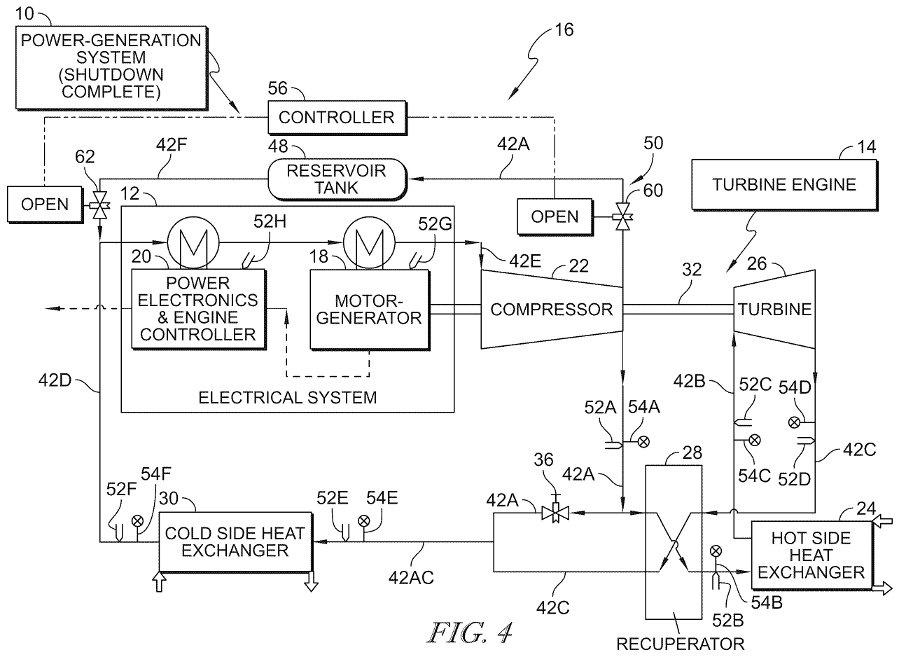

The fluid control system 16 includes the reservoir tank 48, a valve system 50, and a controller 56 coupled to the valve system 50 as shown in FIGS. 1-4. The reservoir tank 48 has an inlet fluidly connected downstream of the compressor 22 and a primary outlet fluidly connected upstream of the electrical system 12. The valve system 50 is fluidly connected to the reservoir tank 48 to control the flow of working fluid through the reservoir tank 48. The valve system 50 is configured to change between an open mode as shown in FIG. 4 and a closed mode as shown in FIGS. 2 and 3. In the closed mode, the valve system 50 blocks the working fluid from flowing through the reservoir tank 48. In the open mode, the valve system 50 allows the working fluid to flow through the reservoir tank 48.

In this way, the working fluid in the reservoir tank 48 may be isolated from the remaining portion of working fluid in the system 10 during operation of the system 10. Additional heat may be transferred from the working fluid in the reservoir tank 48 to the surrounding environment overtime while the reservoir tank 48 is isolated from the rest of the system 10. Thus, the working fluid in the reservoir tank 48 may be kept at a lower temperature to be used to lower the equilibrium temperature after shutdown and maintain the electrical system 12 within the desired temperature thresholds.

In the illustrative embodiment, the valve system 50 includes an inlet valve 60 and an optional outlet valve 62 as shown in FIGS. 1-4. The inlet valve 60 is fluidly connected upstream of the reservoir tank 48. The outlet valve 62 is fluidly connected downstream of the reservoir tank 48. In other embodiments, the outlet valve 62 may be omitted. The inlet and outlet valves 60, 62 are configured to change between an open position as shown in FIGS. 1 and 4 and a closed position as shown in FIGS. 2 and 3. The valves 60, 62 are in the open position when the valve system 50 is in the open mode and the valves 60, 62 are in the closed position when the valve system 50 is in the closed mode.

In the closed position, the inlet valve 60 blocks the compressed working fluid 42A from flowing to the reservoir tank 48 to isolate the reservoir tank from the turbine engine 14. The optional outlet valve 62 blocks the working fluid from flowing from the reservoir tank 48 when in the closed position. In the open position, the inlet valve 60 allows the compressed working fluid 42A to flow to the reservoir tank 48 such that working fluid in the reservoir tank 48 flows to and cools the electrical system 12. The optional outlet valve 62 allows working fluid to flow from the reservoir tank 48 when in the open position.

During normal operation, also referred to as steady-state operation, the controller 56 is configured to direct the valve system 50 to be in the closed mode, i.e., the valves 60, 62 to be in the closed position, to block the working fluid from flowing into and out of the reservoir tank 48. During a shutdown of the turbine engine 14, in which a speed of the compressor 22 and the turbine 26 is below the predetermined speed, the controller 56 is configured to direct the valve system 50 to be in the open mode, i.e., the valves 60, 62 to be in the open position, to allow the working fluid to flow to and from the reservoir tank 48.

As a result, the working fluid in the reservoir tank 48 adds additional thermal mass to the system 10, lowering the equilibrium temperature of the system 10 after shutdown. Additionally, the cooling working fluid in the reservoir tank 48 flows directly to the electrical system 12 thereby providing additional cooling for the electrical system 12 after shutdown. This prevents exposing the electrical system 12 to the high-temperature working fluid after the shutdown of the system 10.

The valve system 50 may also be configured to change to a charging mode as shown in FIG. 1. In the charge mode, the inlet valve 60 is in the open position and the outlet valve 62 remains in the closed position as shown in FIG. 1. The inlet valve 60 allows the compressed working fluid 42A to flow to the reservoir tank 48, while the outlet valve 62 blocks the working fluid from flowing from the reservoir tank 48. By bleeding the compressed working fluid 42A from the compressor 22 to the reservoir tank 48 and blocking it from flowing from the reservoir tank 48, the reservoir tank 48 may be charged to a desired or predetermined pressure. Once the pressure in the reservoir tank 48 reaches the predetermined pressure, the valve system 50 may be changed to the closed mode, isolating the working fluid in the reservoir tank 48 from the rest of the system 10 as suggested by the dotted lines in FIGS. 2 and 3.

With an initial description of the system 10 provided above, the system 10 is hereafter described in further detail. The electrical system 12 includes a motor-generator 18 and an electric power conditioning and distribution system 20 as shown in FIGS. 1-4. The motor-generator 18 of the electrical system 12 is coupled with the turbine engine 14 and operable in a power-generation mode to produce electrical energy and a motor mode to convert the electrical energy into rotational power. The motor-generator 18 operates in the motor mode to start the turbine engine 14 and operates in the power-generation mode to be driven by the turbine engine 14 and generate the electrical energy. In this way, the heat from the heat source 24 may be used to generate electrical energy. The power conditioning and distribution system 20 may supply electrical energy to auxiliary systems. The power conditioning and distribution system 20 may supply electrical energy to auxiliary systems.

The turbine engine 14 includes the compressor 22, the heat source or reactor heat-exchanger 24, the turbine 26, the heat recuperator 28, and the cooling heat-exchanger 30 as shown in FIGS. 1-4. The reactor heat-exchanger 24 is also sometimes referred to as the hot side heat-exchanger 24. The cooling heat-exchanger 30 is also sometimes referred to as the cold side heat-exchanger 30.

The compressor 22 of the turbine engine 14 compresses the working fluid 42E to provide the compressed working fluid 42A, as shown in FIGS. 1-4. From the compressor 22, the compressed working fluid 42A is conducted toward the heat recuperator 28 and the reactor heat-exchanger 24. A portion of the compressed working fluid 42A may be conducted to the reservoir tank 48 when the valve system 50 is in the open mode, i.e., the inlet valve 60 is in the open position. A portion of the compressed working fluid 42A may also be conducted from the outlet of the compressor 22 toward the cooling heat-exchanger 30 via a bypass valve 36 if operating conditions (pressure, temperatures, etc.) are met.

The compressed working fluid 42A flows from an outlet of the compressor 22, through the heat recuperator 28, and to the heat source 24. In the illustrative embodiment, the compressed working fluid 42A flows from the outlet of the compressor 22, through the heat recuperator 28, and to the reactor heat-exchanger 24, as shown in FIGS. 1-4. The reactor heat-exchanger 24 transfers heat from a nuclear reactor 25 to the compressed working fluid 42A to provide heated compressed working fluid 42B.

In the illustrative embodiment, the reactor heat-exchanger 24 is fluidly coupled with the nuclear reactor 25 to transfer heat from a hot fluid of the nuclear reactor 25 to the compressed working fluid 42A. In other embodiments, other heat sources may be used to heat the compressed working fluid 42A.

The heated compressed working fluid 42B from the reactor heat-exchanger 24 is conducted to an inlet of the turbine 26, as shown in FIGS. 1-4. The turbine 26 extracts work from the heated compressed working fluid 42B to drive the compressor 22 and the motor-generator 18 through a shaft 32. The compressor 22 and the motor-generator 18 are directly driven by the turbine 26 in the illustrative embodiment. In other embodiments, the compressor 22 and/or the motor-generator 18 are indirectly driven by the turbine 26 via transmissions, gearboxes, additional generator/battery systems, etc.

In the illustrative embodiment, from an outlet of the turbine 26, a low-pressure working fluid 42C flows to the heat recuperator 28, as shown in FIGS. 1-4. The heat recuperator 28 is arranged between the compressor 22 and the reactor heat-exchanger 24. The heat recuperator 28 receives the low-pressure working fluid 42C from the turbine 26 and transfers heat from the low-pressure working fluid 42C to the compressed working fluid 42A passing from the compressor 22 to the reactor heat-exchanger 24. Thus, heat is transferred to the compressed working fluid 42A in each of the heat recuperator 28 (via the low-pressure working fluid 42C) and the reactor heat-exchanger 24 (via the hot fluid of the nuclear reactor 25) before the heated compressed working fluid 42B flows to the inlet of the turbine 26. In other embodiments, the heat recuperator 28 is omitted.

The low-pressure working fluid 42C flows from the heat recuperator 28 to the cooling heat-exchanger 30, as shown in FIGS. 1-4. The cooling heat-exchanger 30 is located downstream of the turbine 26 and the heat recuperator 28. The cooling heat-exchanger 30 may also receive a portion of the compressed working fluid 42A from the outlet of the compressor 22 depending on the position of the bypass valve 36. The cooling heat-exchanger 30 transfers heat away from the working fluid 42AC via a cooling fluid flowing through the cooling heat-exchanger 30.

Cooled working fluid 42D exits the cooling heat-exchanger 30 and flows toward the electrical system 12 and the compressor 22, as shown in FIGS. 1-4. The electrical system 12 transfers heat to the cooled working fluid 42D. The working fluid 42E then flows to the compressor 22 where it is compressed to provide compressed working fluid 42A, and the compressed working fluid 42A recirculates through the cycle of the turbine engine 14. Thus, the system 10 is a closed loop system where the working fluid is recirculated through the system 10.

The fluid control system 16 includes the reservoir tank 48, the valve system 50, a plurality of sensors 52A-H, 54A-F, and the controller 56 coupled to the valve system 50 and the sensors 52A-H, 54A-F as shown in FIGS. 1-4. The valve system 50 controls the flow of the working fluid to the reservoir tank 48. The plurality of sensors 52A-H, 54A-F includes temperature sensors 52A-F configured to measure a temperature of the working fluid in the system 10, temperature sensors 52G, 52H configured to measure the temperature of the electrical system 12, and pressure sensors 54A-F configured to measure the pressure of the working fluid in the system 10.

In the illustrative embodiment, the valve system 50 includes the inlet valve 60 and the outlet valve 62 as shown in FIGS. 1-4. The inlet valve 60 is fluidly connected upstream of the reservoir tank 48 and the outlet valve is fluidly connected downstream of the reservoir tank 48 and upstream of the electrical system 12. In other embodiments, the valve system 50 only includes the inlet valve 60 fluidly connected downstream of the compressor 22 and upstream of the reservoir tank 48. In some embodiments, the inlet and outlet of the reservoir tank 48 may be integrally formed with an inlet valve 60 and an outlet valve 62.

The plurality of sensors 52A-H, 54A-F includes a first temperature sensor 52A, a second temperature sensor 52B, a third temperature sensor 52C, a fourth temperature sensor 52D, a fifth temperature sensor 52E, and a sixth temperature sensor 52F as shown in FIGS. 1-4. The first temperature sensor 52A is positioned downstream of the compressor 22 and upstream of the recuperator 28. The second temperature sensor 52B is positioned downstream of the recuperator 28 and upstream of the reactor heat-exchanger 24. The third sensor 52C is positioned downstream of the reactor heat-exchanger 24 and upstream of the turbine 26. The fourth sensor 52D is positioned downstream of the turbine 26 and upstream of the recuperator 28. The fifth sensor 52E is positioned upstream of the cooling heat-exchanger 30 and downstream of the recuperator 28 and the compressor. The sixth sensor 52F is positioned downstream of the cooling heat-exchanger 30 and upstream of the electrical system 12.

The plurality of sensors 52A-H, 54A-F includes a seventh sensor 52G and an eighth sensor 52H as shown in FIGS. 1-4. The seventh sensor 52G is in thermal communication with the motor-generator 18 of the electrical system 12 to measure the temperature of the motor-generator 18. The eighth sensor 52H is in thermal communication with the power conditioning and distribution system 20 of the electrical system 12 to measure the temperature of the power conditioning and distribution system 20.

The plurality of sensors 54A-F, 54A-F includes a first pressure sensor 54A, a second pressure sensor 54B, a third pressure sensor 54C, a fourth pressure sensor 54D, a fifth pressure sensor 54E, and a sixth pressure sensor 54F. The first pressure sensor 54A is positioned downstream of the compressor 22 and upstream of the recuperator 28. The second pressure sensor 54B is positioned downstream of the recuperator 28 and upstream of the reactor heat-exchanger 24. The third sensor 54C is positioned downstream of the reactor heat-exchanger 24 and upstream of the turbine 26. The fourth sensor 54D is positioned downstream of the turbine 26 and upstream of the recuperator 28. The fifth sensor 54E is positioned upstream of the cooling heat-exchanger 30 and downstream of the recuperator 28 and the compressor. The sixth sensor 54F is positioned downstream of the cooling heat-exchanger 30 and upstream of the electrical system 12.

The controller 56 is coupled to the valve system 50 to move the valve system 50 between the charging mode as shown in FIG. 1, the open mode as shown in FIG. 4, and the closed mode as shown in FIGS. 2 and 3. In the charging mode, the valve system 50 allows the compressed working fluid 42A from the compressor 22 to flow to the reservoir tank 48, but blocks the working fluid from flowing out of the reservoir tank 48. In other words, the inlet valve 60 is in the open position and the outlet valve 62 is in the closed position. In the open mode, the valve system 50 allows the compressed working fluid 42A from the compressor 22 to flow to the reservoir tank 48. In other words, in the open mode, both of the valves 60, 62 are in the open position to allow the working fluid to flow into and out of the reservoir tank 48. In the closed mode, the valve system 50 blocks the compressed working fluid 42A from flowing into the reservoir tank 48. In other words, in the closed mode, the valves 60, 62 are in the closed position block the working fluid from flowing into and out of the reservoir tank 48.

The controller 56 directs the valve system 50 to change between the charging, open, and closed modes based on the operation of the system 10. In other words, the controller 56 directs the valves 60, 62 to change between the open and closed positions based on the operation of the system 10.

During start-up of the turbine engine 14, the controller 56 directs the inlet valve 60 to be in the open position and the outlet valve 62 to be in the closed position, i.e., the valve system 50 to be in the charging mode. After initial start-up, i.e., the reservoir tank charging mode, the valve system 50 is in the charging mode to bleed the compressed working fluid 42A from the compressor 22 to the reservoir tank 48.

The valve system 50 is kept in the charging mode to charge the reservoir tank 48 to a desired or predetermined pressure. Once the pressure in the reservoir tank 48 reaches the predetermined pressure, the controller 56 directs the valve system 50 to change to the closed mode. This isolates the working fluid in the reservoir tank 48 from the rest of the system 10 as suggested by the dotted lines in FIGS. 2 and 3.

The controller 56 directs the valve system 50 to be in the closed mode, i.e., the valves 60, 62 to be in the closed position, in response to operation of the turbine engine 14. In a normal operation mode, the turbine engine 14 is running at a sufficient speed to provide cool air to the cold side volume of the system 10. Therefore, while the turbine engine 14 is running, the controller 56 may direct the valves 60, 62 to be in the closed position. As suggested by the dotted line in FIGS. 2 and 3, the flow through the reservoir tank 48 is blocked when the valve system 50 is in the closed mode.

A shutdown may be initiated for multiple reasons. In some embodiments, a user may direct the system 10 to initiate a shutdown. In some embodiments, the shutdown may be initiated based on the measurements from the plurality of sensors 52A-H, 54A-F.

Once a shutdown sequence is initiated, the turbine inlet temperature is lowered to the lowest value possible to maintain a self-sustaining cycle with the working fluid still circulating in the system 10. The speed of the turbine engine 14 is reduced to lowest value possible which to lower exit temperature of the compressor 22 and to lower inlet temperature of the cooling heat-exchanger 30. As turbine engine 14 comes to a stop, the speed of the compressor 22 and the turbine 26 drops below a predetermined speed.

The controller 56 directs the valve system 50 to be in the open mode, i.e., the valves 60, 62 to be in the open position in response to a shutdown of the turbine engine 14. In other words, the controller 56 directs the valves 60, 62 to be in the open position in response to a speed of the compressor 22 and the turbine 26 being below the predetermined speed.

In some embodiments, the predetermined speed is greater than zero or before the turbine engine 14 comes to a full stop. In some embodiments, the predetermined speed is zero or when the turbine engine 14 reaches a full stop. In some embodiments, the controller 56 may direct the valves 60, 62 to be in the open position in response to a temperature measurement from one of the sensors 52A-H during a shutdown.

In the open mode, the inlet and outlet valves 60, 62 allow the working fluid to and from the reservoir tank 48. The working fluid 42F from the reservoir tank 48 is at a lower temperature thereby increasing the thermal mass of the system 10. The working fluid 42F flows to the electrical system 12 to help further cool the electrical system 12 and maintain the electrical system 12 within the desired temperature thresholds.

The total working fluid temperature, or the equilibrium temperature, may be higher than the operating temperature limits of the power electronics of the electrical system 12. The hot side of the system 10, which includes the reactor heat-exchanger 24, the turbine 26, and the recuperator 28, is at a higher temperature at shutdown than the cold side of the system 10, which includes the cooling heat-exchanger 30 and the electrical system 12. The reservoir tank 48 which is filled early during engine operation, then isolated via the valve system 50, and passively cooled prior to shutdown allows for additional cooled working fluid volume in the system 10 to bring temperatures within electronic component temperature limits.

A method of operating the system 10 may include several steps. The method includes compressing a working fluid with the compressor 22, heating the compressed working fluid, and rotating the turbine 26 with the heated working fluid. The method further includes cooling the heated working fluid after rotating the turbine 26 with the heated fluid and cooling at least one electrical component with the cooled working fluid. The system 10 is a closed-loop power generation system 10 such that the working fluid is recirculated through the system 10. Therefore, the method further includes conducting the working fluid from the at least one electrical component to the compressor 22.

The method also includes conducting electrical energy to at least one electrical component of the electrical system 12. The method also includes driving the motor-generator 18 with the work extracted from the turbine 26 to produce the electrical energy. The method also includes converting the electrical energy into rotational power to start the turbine engine 14.

The method also includes conducting at least a portion of the compressed working fluid to the reservoir tank 48 fluidly connected downstream of the compressor 22 in response to a shutdown in which a speed of the compressor 22 and the turbine 26 is below a predetermined speed to cause the working fluid stored in the reservoir tank 48 to flow to the at least one electrical component of the electrical system 12. The step of conducting the compressed working fluid to the reservoir tank 48 includes opening the inlet valve 60. In some embodiments, the step of conducting the compressed working fluid to the reservoir tank 48 includes opening the inlet valve 60 and the optional outlet valve 62.

The method also includes blocking the compressed working fluid from flowing to the reservoir tank 48 in response to a pressure within the reservoir tank 48 being greater than or equal to a predetermined pressure while the turbine engine 14 is operating or running. The step of blocking the compressed working fluid from flowing to the reservoir tank 48 includes shutting the inlet valve 60. In some embodiments, the step of blocking the compressed working fluid from flowing to the reservoir tank 48 includes shutting the inlet valve 60 and the optional outlet valve 62.

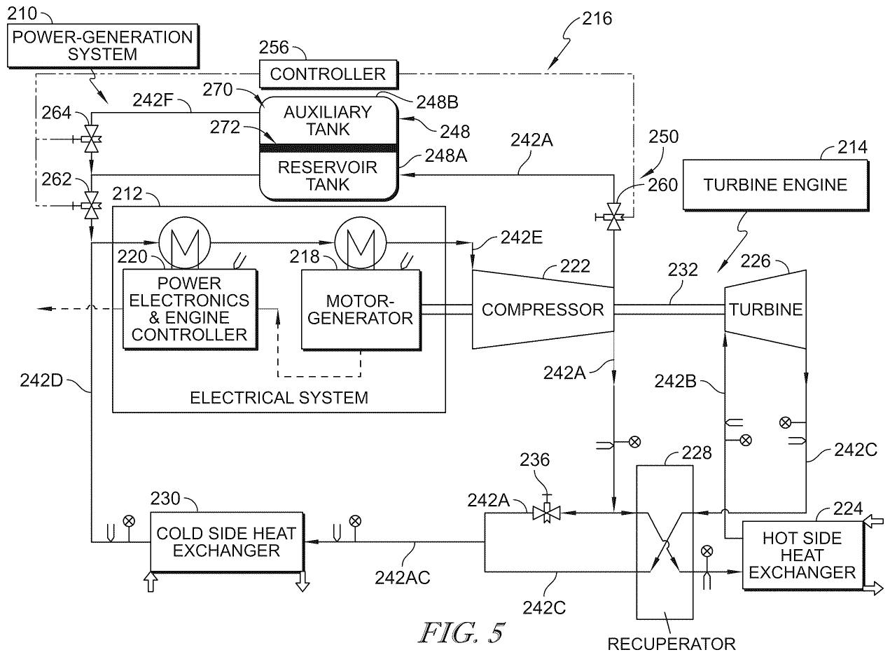

Another embodiment of a power-generation system 210 in accordance with the present disclosure is shown in FIG. 5. The power-generation system 210 is substantially similar to the power-generation system 10 shown in FIGS. 1-4 and described herein. Accordingly, similar reference numbers in the 200 series indicate features that are common between the power-generation system 10 and the power-generation system 210. The description of the power-generation system 10 is incorporated by reference to apply to the power-generation system 210, except in instances when it conflicts with the specific description and the drawings of the power-generation system 10.

The power-generation system 210 includes an electrical system 212, a turbine engine 214, and a fluid control system 216 fluidly connected with the electrical system 212 and the turbine engine 214 to circulate working fluid through the electrical system 212 and the turbine engine 214 as shown in FIG. 5. The fluid control system 216 includes a reservoir tank 248, a valve system 250, and a controller 256 is coupled to the valve system 250 as shown in FIG. 5.

Unlike the reservoir tank 48 in FIGS. 1-4, the reservoir tank 248 includes a main tank section 248A and an auxiliary tank section 248B separate from the main tank section 248A. The reservoir tank 248 has an inlet and a primary outlet that are in fluid communication with the main tank section 248A and a secondary outlet in fluid communication with the auxiliary tank section 248B. The primary and secondary outlets are fluidly connected downstream of the cooling heat-exchanger 230.

While the working fluid in the system 10 may flow through the main tank section 248A, the working fluid in the auxiliary tank section 248B is not normally circulated through the system 10. The working fluid in the auxiliary tank section 248B may transfer heat from the main tank section 248A to help further lower the temperature of the working fluid in the main tank section 248A of the reservoir tank 248. The working fluid in the auxiliary tank section 248B may also be used to recharge the system 10 overtime.

The reservoir tank 248 includes a tank body 270 and an internal divider 272 as shown in FIG. 5. The tank body 270 defines an interior space of the reservoir tank 248. The internal divider 272 is arranged in the interior space of the tank body 270 to divide the interior space into the main tank section 248A and the auxiliary tank section 248B.

The valve system 250 is fluidly connected to the reservoir tank 248 to control the flow of working fluid into and out of the reservoir tank 248. The valve system 250 is configured to change between a charging mode, a partially open mode, a fully opened mode, and a closed mode. In the closed mode, the valve system 250 blocks the working fluid from flowing through the main tank section 248A of the reservoir tank 248 and blocks the working fluid from flow out of the auxiliary tank section 248B of the reservoir tank 248. In the partially open mode, like the open mode in FIGS. 1 and 4, the valve system 250 allows the working fluid to flow through the main tank section 248A of the reservoir tank 248. In the fully open mode, the valve system 250 allows the working fluid to flow through the main tank section 248A of the reservoir tank 248 and also allows fluid to flow from the auxiliary tank section 248B of the reservoir tank 248. In the charging mode, the valve system 250 allows the working fluid to flow to the main tank section 248A of the reservoir tank 248 and blocks the working fluid from flowing the main tank and the auxiliary tank sections 248A, 248B of the reservoir tank 248.

The valve system 250 includes an inlet valve 260, a first outlet valve 264, and an optional outlet valve 262 as shown in FIG. 5. The inlet valve 260 is fluidly connected upstream of the reservoir tank 248. The first outlet valve 264 is fluid connected downstream of the secondary outlet of the reservoir tank 248 and upstream of the primary outlet of the reservoir tank 248. The optional second outlet valve 262 may be fluidly connected downstream of the primary outlet of the reservoir tank 248 and downstream of the first outlet valve 264. In other embodiments, the outlet valve 62 is omitted.

In the illustrative embodiment, the first outlet valve 264 is separate from the reservoir tank 248. In other embodiments, the first outlet valve 264 may be integrally formed with the reservoir tank 248 at the auxiliary tank section 248B.

The inlet and outlet valves 260, 262, 264 are configured to change between an open position and a closed position. In the open position, the valves 260, 262, 264 allow the working fluid to flow therethrough. In the closed position, the valves 260, 262, 264 block the working fluid from flowing therethrough. The valve 260 is in the open position and the valves 262, 264 are in the closed position when the valve system 250 is in the charging mode. The valves 260, 262 are in the open position and the outlet valve 264 is in the closed position when the valve system 250 is in the partially open mode. The valves 260, 262, 264 are in the open position when the valve system 250 is in the fully opened mode. The valves 260, 262, 264 are in the closed position when the valve system 250 is in the closed mode.

The controller 256 directs the valve system 250 to change between the charging mode, the partially open mode, the fully opened mode, and the closed mode based on the operation of the system 210. During normal operation, also referred to as steady-state operation, the controller 256 is configured to direct the valve system 250 to be in the closed mode, i.e., the valves 260, 262, 264 to be in the closed position, to block the working fluid from flowing into and out of the reservoir tank 248. During a shutdown of the turbine engine 214, in which a speed of the turbine engine 214 is below the predetermined speed, the controller 256 is configured to direct the valve system 250 to at least be in the partially open mode, i.e., the valves 260, 262 to be in the open position, to allow the working fluid to flow to and from the main tank section 248A reservoir tank 248.

The electrical system 212 includes a motor-generator 218 and an electric power conditioning and distribution system 220 as shown in FIG. 5. The motor-generator 218 of the electrical system 212 is coupled with the turbine engine 214 and operable in a power-generation mode to produce electrical energy and a motor mode to convert the electrical energy into rotational power.

The turbine engine 214 includes a compressor 222 that compresses a working fluid 242E to provide compressed working fluid 242A, a heat source 224, illustratively a reactor heat-exchanger 224, downstream of the compressor 222 that heats the compressed working fluid 242A to provide heated compressed working fluid 242B, and a turbine 226 downstream of the heat source 224 that extracts work from the heated compressed working fluid 242B to provide low-pressure working fluid 242C and drive rotation of the compressor 222.

The compressor 222 of the turbine engine 214 compresses the working fluid 242E to provide the compressed working fluid 42A. From the compressor 222, the compressed working fluid 242A is conducted toward the heat recuperator 228 and the reactor heat-exchanger 224. A portion of the compressed working fluid 242A may be conducted to the reservoir tank 248 when the valve system 250 is in one of the open modes, i.e., the inlet valve 260 is in the open position. A portion of the compressed working fluid 242A may also be conducted from the outlet of the compressor 222 toward the cooling heat-exchanger 230 via a bypass valve 236 if operating conditions (pressure, temperatures, etc.) are met.

The compressed working fluid 242A flows from an outlet of the compressor 222, through the heat recuperator 228, and to the heat source 224. In the illustrative embodiment, the compressed working fluid 242A flows from the outlet of the compressor 222, through the heat recuperator 228, and to the reactor heat-exchanger 224, as shown in FIG. 5. The reactor heat-exchanger 224 transfers heat from a nuclear reactor 225 to the compressed working fluid 242A to provide heated compressed working fluid 242B.

The heated compressed working fluid 242B from the reactor heat-exchanger 224 is conducted to an inlet of the turbine 226, as shown in FIG. 5. The turbine 226 extracts work from the heated compressed working fluid 242B to drive the compressor 222 and the motor-generator 218 through a shaft 232. The compressor 222 and the motor-generator 218 are directly driven by the turbine 226 in the illustrative embodiment. In other embodiments, the compressor 222 and/or the motor-generator 18 are indirectly driven by the turbine 226 via transmissions, gearboxes, additional generator/battery systems, etc.

In the illustrative embodiment, from an outlet of the turbine 226, a low-pressure working fluid 242C flows to the heat recuperator 228, as shown in FIG. 5. The heat recuperator 228 is arranged between the compressor 222 and the reactor heat-exchanger 224. The heat recuperator 228 receives the low-pressure working fluid 242C from the turbine 226 and transfers heat from the low-pressure working fluid 242C to the compressed working fluid 242A passing from the compressor 222 to the reactor heat-exchanger 24. Thus, heat is transferred to the compressed working fluid 242A in each of the heat recuperator 228 (via the low-pressure working fluid 242C) and the reactor heat-exchanger 224 (via the hot fluid of the nuclear reactor 225) before the heated compressed working fluid 242B flows to the inlet of the turbine 226. In other embodiments, the heat recuperator 228 is omitted.

The low-pressure working fluid 242C flows from the heat recuperator 228 to the cooling heat-exchanger 230, as shown in FIG. 5. The cooling heat-exchanger 230 is located downstream of the turbine 226 and the heat recuperator 228. The cooling heat-exchanger 230 may also receive a portion of the compressed working fluid 242A from the outlet of the compressor 222 depending on the position of the bypass valve 236. The cooling heat-exchanger 230 transfers heat away from the working fluid 242AC via a cooling fluid flowing through the cooling heat-exchanger 230.

Cooled working fluid 242D exits the cooling heat-exchanger 230 and flows toward the electrical system 212 and the compressor 222, as shown in FIG. 5. The electrical system 212 transfers heat to the cooled working fluid 242D. The working fluid 242E then flows to the compressor 222 where it is compressed to provide compressed working fluid 242A, and the compressed working fluid 242A recirculates through the cycle of the turbine engine 214.

As shown in FIG. 5, the fluid control system 216 further includes a plurality of sensors 252A-H, 254A-F. The plurality of sensors 252A-H, 254A-F includes temperature sensors 252A-F configured to measure a temperature of the working fluid in the system 210, temperature sensors 252G, 252H configured to measure the temperature of the electrical system 212, and pressure sensors 254A-F configured to measure the pressure of the working fluid in the system 10.

Closed Brayton cycle systems may be used for terrestrial or space satellite power generation using nuclear reactions. Closed Brayton cycle systems may be used with a nuclear reactor to provide a combustion heat source. Closed Brayton cycle systems may be more efficient at converting nuclear reactor heat to electric power than traditional methods such as a radioisotope generator converting heat to power.

Due to the harsh environment around space and other terrestrial uses, it may be difficult to service the hardware and long component life is desirable. It may be advantageous to keep electrical components cool for improved reliability. Cooled working fluid may be used to maintain long-life operating temperatures of motor-generator and power conditioning and distribution systems.

There are temperature limits for typical electrical components used to convert mechanical energy into electrical power, including both the power electronics and/or the alternator/generator. To minimize components and secondary cooling systems the thermal management of the power conversion system may, during steady state operation, be maintained by the working fluid passing across power conversion cooling systems after passing through the cooling heat-exchanger 30 of the system 10. The cooling heat-exchanger 30 lowers the temperature of the working fluid to an acceptable range for the electrical system 12.

The ability to pass the desired cool working fluid across the power conversion system may only be maintained while the turbomachinery is moving fluid throughout the system. Upon shut down of the turbomachinery, the closed system will tend towards an equilibrium temperature with the higher temperature and pressure states (e.g., within the turbine) dominating the overall equilibrium. This is due to the significantly higher volume of fluid at high temperatures rather than lower temperatures. The equilibrium temperature is significantly higher than the operating temperature limits of the power electronics.

The fluid control system 16 is configured to prevent the delicate power conversion equipment from being exposed to these temperatures during shutdown. The fluid control system 16 includes the reservoir tank 48 and the valve system 50 with valves located upstream of the electrical system 12 and downstream of the exit of the compressor 22. The reservoir tank 248 may also be integrated with an auxiliary tank section 248B which contains an auxiliary portion of fluid which is not circulated with the primary working fluid. This auxiliary portion of working fluid in the auxiliary tank section 248B may be used to recharge the system 210 over time.

Including reservoir tank 48, 248 acts as an additional thermal mass when the reservoir tank valve(s) 60, 62, 260, 262, 264 are opened. This is in lieu of using outside energy source(s) to motor the turbomachinery below the self-sustainment speeds.

After initial start-up, the valve system 50, 250 is kept in the open mode or the partially open mode to bleed compressed working fluid to the reservoir tank 48, 248. The compressed working fluid is diverted into the reservoir tank 48, 248 until the reservoir tank 48, 248 is charged to a sufficiently high pressure or a predetermined pressure. Then the valve system 50, 250 is changed to the closed mode.

While the turbine engine 14, 214 is running, providing sufficiently cool air to the cold side volume including the electrical system 12, 212, the valve system 50, 250 is in the closed mode. Over time, heat is naturally radiated to the environment or to the auxiliary tank section 248B of the reservoir tank 248 to further cool the working fluid in the reservoir tank 48, 248.

A shutdown sequence is then initiated such that turbine inlet temperature is lowered to the lowest value possible to maintain a self-sustaining cycle with fluid still flowing. The system operating speed is reduced to lowest value possible, which lowers the compressor exit temperature and lowers the cold side heat exchanger inlet temperature. As turbomachinery comes to a stop, the valve system 50, 250 is changed to the open mode or partially open mode. The closing of the valves 60, 62, 260, 262 prevents the hot working fluid from washing over the electronic components of the electrical system 12, 212.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A power-generation system comprising:
an electrical system including a motor-generator and an electric power conditioning and distribution system connected with the motor-generator, the motor-generator operable in a power-generation mode to produce electrical energy and a motor mode to convert the electrical energy into rotational power, and the electrical system configured for fluid cooling for removing heat from the electrical system,
a turbine engine including a compressor configured to receive a working fluid and compress the working fluid to provide a compressed working fluid, a reactor heat-exchanger downstream of the compressor that transfers heat from a nuclear reactor to the compressed working fluid to provide a heated working fluid, a turbine downstream of the reactor heat-exchanger and configured to extract work from the heated working fluid and drive rotation of the compressor and the motor-generator, and a cooling heat-exchanger downstream of the turbine to transfer heat away from the heated working fluid to provide a cooled working fluid,
a fluid control system fluidly connected with the electrical system and the turbine engine to circulate the working fluid through the electrical system and the turbine engine, the fluid control system including:
a reservoir tank configured to store an amount of the working fluid, the reservoir tank having an inlet fluidly connected downstream of the compressor and a primary outlet fluidly connected upstream of the electrical system,
an inlet valve located upstream of the reservoir tank and configured to change between an open position in which the inlet valve allows the compressed working fluid to flow to the reservoir tank and a closed position in which the inlet valve blocks the compressed working fluid to the reservoir tank to isolate the reservoir tank from the turbine engine, and
a controller coupled to the inlet valve and configured to direct the inlet valve to change from the closed position to the open position in response to a shutdown of the turbine engine in which a speed of the compressor and the turbine is below a predetermined speed to allow the working fluid in the reservoir tank to flow to the electrical system so as to lower an overall equilibrium temperature of the working fluid after the shutdown of the turbine engine.

2. The power-generation system of claim 1, wherein the controller is configured to direct the inlet valve to be in the closed position during a start-up of the turbine engine and direct the inlet valve to change from the closed position to the open position after the start-up of the turbine engine to divert compressed working fluid to the reservoir tank.

3. The power-generation system of claim 2, wherein the controller is configured to direct the inlet valve to change from the open position to the closed position after the start-up of the turbine engine in response to a pressure of the reservoir tank being equal to or greater than a predetermined pressure.

4. The power-generation system of claim 1, wherein the reservoir tank includes a main tank section and an auxiliary tank section separate from the main tank section, wherein the reservoir tank has a secondary outlet fluidly connected downstream of the cooling heat-exchanger, and wherein the inlet and the primary outlet are in fluid communication with the main tank section and the secondary outlet is in fluid communication with the auxiliary tank section.

5. The power-generation system of claim 4, wherein the reservoir tank includes a tank body that defines an interior space of the reservoir tank and an internal divider in the interior space that divides the interior space into the main tank section and the auxiliary tank section.

6. The power-generation system of claim 4, wherein the fluid control system further includes at least one outlet valve downstream of the reservoir tank, the at least one outlet valve configured to change between the open position in which the at least one outlet valve allows the working fluid stored in the reservoir tank to flow to the electrical system and the closed position in which the at least one outlet valve blocks the working fluid from flowing from the reservoir tank.

7. The power-generation system of claim 6, wherein the fluid control system includes a first outlet valve located downstream of the secondary outlet of the reservoir tank and upstream of the primary outlet of the reservoir tank.

8. The power-generation system of claim 7, wherein the fluid control system further includes a second outlet valve located downstream of the primary outlet of the reservoir tank and downstream of the first outlet valve.

9. The power-generation system of claim 1, wherein the fluid control system further includes an outlet valve located downstream of the reservoir tank, the outlet valve configured to change between the open position in which the outlet valve allows the working fluid stored in the reservoir tank to flow to the electrical system and the closed position in which the outlet valve blocks the working fluid from flowing from the reservoir tank.

10. The power-generation system of claim 1, wherein the motor-generator is coupled with the compressor and configured to operate in the motor mode to start the turbine engine and to operate in the power-generation mode to be driven by the turbine and generate the electrical energy.

11. A power-generation system comprising:
an electrical system,
a turbine engine including a compressor configured to receive a working fluid and compress the working fluid to provide a compressed working fluid, a heat source that transfers heat to the compressed working fluid to provide a heated working fluid, a turbine fluidly connected with the compressor to extract work from the heated working fluid and drive rotation of the compressor, and a first heat-exchanger fluidly connected with the turbine to transfer heat away from the heated working fluid to provide a cooled working fluid, and
a fluid control system including:
a reservoir tank fluidly connected downstream of the compressor and upstream of the electrical system and configured to store an amount of the working fluid,
a valve system fluidly connected to the reservoir tank to control a flow of working fluid through the reservoir tank, and
a controller coupled to the valve system to move the valve system between a closed mode in which the valve system blocks the working fluid from flowing through the reservoir tank in response to operation of the turbine engine and an open mode in which the valve system allows the working fluid to flow through the reservoir tank in response to a shutdown of the turbine engine.

12. The power-generation system of claim 11, wherein the controller is configured to direct the valve system to be in the closed mode during a start-up of the turbine engine and direct the valve system to change from the closed mode to a charging mode after the start-up of the turbine engine in which the valve system allows the working fluid to flow to the reservoir tank and blocks the working fluid from flowing from the reservoir tank.

13. The power-generation system of claim 12, wherein the controller is configured to direct the valve system to change from the charging mode to the closed mode after a start-up of the turbine engine in response to a pressure of the reservoir tank being equal to or greater than a predetermined pressure.

14. The power-generation system of claim 11, wherein the reservoir tank includes a main tank section and an auxiliary tank section separate from the main tank section, wherein the reservoir tank has an inlet fluidly connected downstream of the compressor, a primary outlet fluidly connected upstream of the electrical system, and a secondary outlet fluidly connected downstream of the first heat-exchanger, and wherein the inlet and the primary outlet are in fluid communication with the main tank section and the secondary outlet is in fluid communication with the auxiliary tank section.

15. The power-generation system of claim 14, wherein the reservoir tank includes a tank body that defines an interior space of the reservoir tank and an internal divider in the interior space that divides the interior space into the main tank section and the auxiliary tank section.

16. The power-generation system of claim 14, wherein the valve system includes an inlet valve located upstream of the reservoir tank.

17. The power-generation system of claim 16, wherein the valve system further includes at least one outlet valve located downstream of the reservoir tank.

18. The power-generation system of claim 17, the valve system further includes a first outlet valve located downstream of the secondary outlet of the reservoir tank and upstream of the primary outlet of the reservoir tank and a second outlet valve located downstream of the primary outlet of the reservoir tank and downstream of the first outlet valve.

19. A method of operating a power-generation system, the method comprising:
compressing a working fluid with a compressor,
heating the compressed working fluid,
rotating a turbine with the heated working fluid,
cooling the heated working fluid after rotating the turbine with the heated fluid,
conducting electrical energy to at least one electrical component,
cooling the at least one electrical component with the cooled working fluid,
conducting the working fluid from the at least one electrical component to the compressor, and
conducting at least a portion of the compressed working fluid to a reservoir tank fluidly connected downstream of the compressor in response to a shutdown in which a speed of the compressor and the turbine is below a predetermined speed to cause the working fluid stored in the reservoir tank to flow to the at least one electrical component.

20. The method of claim 19, wherein the reservoir tank includes a main tank section and an auxiliary tank section separate from the main tank section, and wherein the method further includes selectively conducting the working fluid stored in the auxiliary tank section to the at least one electrical component.
